(19) United States
(12) Patent Application Publication
(10) Pub. No.: US 2025/0229570 A1
(43) Pub. Date: Jul. 17, 2025

(54) Reusable inflatable Balloon Arch

(71) Applicant: Tomas Gloetzner, Poolesville, MD (US)

(72) Inventor: Tomas Gloetzner, Poolesville, MD (US)

(21) Appl. No.: 18/930,649

(22) Filed: Oct. 29, 2024

(51) Int. Cl. B44F 99/00; A63H 27/10

(52) U.S. Cl. CPC B44F 99/00; A63H 27/10; A63H 2027/1033

(57) ABSTRACT

A novel form of balloon arch equipped with a blower offers reusability and ease of use compared to conventional balloon arches. The assembly, made from polyester and ripstop materials, ensures the arch is durable and long-lasting. Using a 3D-modeling process, individual polyester pieces are identified, cut, and sewn together to produce a design. The arch's functionality allows for inflation within 1-5 minutes, making it a decoration choice for parties and celebrations. The arch is available in colors to accommodate preferences. Once the arch has served its purpose, disconnecting and unzipping the air outlets deflates it, making it easy to store for future use. The single-piece inflatable assembly is designed to resemble an arch constructed from balloons. With the blower providing air, the arch remains inflated until disconnected. The arch is available in materials and colors, making it a choice for any occasion.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

The present embodiments pertain to methods, devices, and systems for furnishing a reusable inflatable balloon arch that exhibits the same visual display as traditional arches, while demanding minimal exertion, and can be employed repeatedly.

### Description of the Related Art

Balloons have been used as decorations for decades, but they have enjoyed increased usage in the recent past. There are two types of balloons commonly used for decor plus a variety of patented, specialty balloons.

Balloons have traditionally been made of natural latex. Molds are dipped into a vat of liquid latex. Some of the latex adheres to the mold. The mold is removed and the adhered latex dries into a highly elastic membrane. The membrane is removed from the mold for use. The balloon thus created is usually a bulbous form with a single, narrow, tubular stem, and opening for inflation. Once inflated, latex balloons are most commonly sealed by tying a knot in the inflation stem of the balloon. Less common are the use of mechanical fasteners and internally installed, self-sealing valves to seal latex balloons.

There are a large variety of techniques and systems used in the trade to connect latex balloons directly to each other to some common material or object to serve structural and decorative functions. There are, however, relatively few systems especially designed and manufactured for these purposes.

Adhesives are commonly applied to at least one of the surfaces to be connected and the surfaces pressed together and held until the adhesive has set sufficiently to keep the surfaces in contact without special assistance. The adhesives come in a variety of forms, including sprays, liquids, temperature-based adhesives, and tapes.

There are several mechanical methods for connecting balloons. These include twisting, tying, pinching, and squeezing balloons directly to each other and/or to some structures in common connection with other balloons.

Balloons have long been tied to each other at the neck (the inflation stem) of the balloon. The long, slender balloons (often called “pencil balloons” or “entertainer balloons”) are often pinched and twisted at various points along their length. Those points of twisting are themselves twisted together with other such points on the same or other balloons. Balloons have long been tied with and tied to such things such as string, ribbon, monofiliment (plastic or nylon fishing line), wire, and cable ties.

Balloons are often attached to each other or to common structures by actually piercing the skin of the balloon in the section of the balloon stem which is not being used to seal the air chamber. This is often done with paper clips or other sections of wire which are then hooked, twisted or tied to each other or to more substantial structures.

Lighter-weight metal rods and tubes, as well as plastic rods and tubes are frequently framing materials of choice as they come in forms stiff enough to keep balloons in planned arrangements and are still flexible enough to be formed by hand or with simple tools. When large numbers of balloons are to be contained, frequently the control is supplied by using bags or nets.

There are an enormous variety of combinations of specific techniques for using adhesives and similar complexities available in mechanical techniques as well. When the two approaches are combined the possibilities multiply again.

For example, adhesives can be used to stick balloons to each other to form a sheet of balloons. The sheet might then be bent into a curved surface and held in that shape by mechanical connections. Such a sheet might form a decorative wall, a canopy or a tunnel.

Helium-filled balloons might be connected mechanically to a light weight line so that they float into an arch. The balloons might then be stuck to each other with adhesives to assure that the balloons do not spin around and hide important graphics on their surfaces.

The use of grids has followed two basic paradigms. The first paradigm employs holes cut in sheets of material. Selected holes hold balloons by squeezing the balloon into the hole or by passing the stem or a tie connected to the balloon through the hole and attaching it to the material. While these cut outs are generally accomplished with an efficient die cutting process, this paradigm generates considerable waste from the cut outs made in the processing. The framing elements (around the apertures) and the apertures remain essentially the same size when put to use as they are at the time of manufacture. The finished display is limited to the original size of the sheet plus overhang from the connected balloons.

The second paradigm assembles elements utilizing basically rigid joints. Such an (approach usually has less wasted material than in the first paradigm, but has the added expense of making those joints. The framing elements (around the apertures) and the apertures remain essentially the same size when put to use as they are at the time of manufacture. The finished display is limited to the size of the manufactured framework plus overhang from the connected balloons.

The use of these common techniques along with manufactured frameworks has developed largely in the last decade. There have been only a few of these frameworks designed and manufactured specifically for use with balloons.

For example, in 1985 Marvin Hardy reports using pegboard as a framework to hold balloons with the necks of balloons pulled through the regular pattern of small holes in these sheets of composite wood. Over the next years he used slotted plastic disks to pinch the necks of the balloons to keep them from pulling back through the holes. Spoony Morrill, according to August 1987 issue of Balloons Today magazine, introduced the use of existing, flexible, net grids as framework for balloon graphics. Balloons were attached in a single layer with paper clips or by tying them directly to the nets.

Graham Rouse, in March 1988 at a convention of the National Association of Balloon Artists, introduced Rouse Balloon Art Designer Panels™ specifically designed and produced for balloon decorating. These corrugated board panels form a regular, semirigid, and modular system having an array of apertures to connect and hold balloons in a network for walls and other graphic and sculptural displays. Balloons were generally attached by pulling the neck of a balloon through one hole, stretching the neck to a slit radiating from an adjacent hole, and then pinching the neck in the slit.

Later that year, in July, the Rouse Balloon Art Designer Panels™ were exhibited at the Flowers, Inc. Balloons open house as a system for squeezing balloons into apertures smaller than the natural diameter of the inflated balloons in order to hold the balloons in place for graphic and sculptural displays.

In 1990, Marvin Hardy began to use his Jiffy Strips™, which are ¾″ wide strips of translucent plastic having small holes and slits at 1″ intervals to hold balloons tightly against the strips by stretching the neck through a hole and then pinching the balloon neck into an adjacent slit. Jiffy Strips™ may be placed at right angles to form grids or grouped in roughly parallel strips to cover large and irregular surfaces.

About the same time, Kevin LaCount used manufactured wooden lattices to hold balloons by squeezing the balloons into the openings in the lattice. In commercial decoration applications, David Gully used manufactured wire grids into which he squeezed balloons to create decorative patterns.

In 1993, Marvin Hardy introduced his MagiGrid™. This looks much like a rectangular grid wire fence only made of heavier metal rods and straps. The size of the openings may be changed from one use to the next. Balloons are squeezed sideways (i.e., held by pressure against top, bottom, and two sides) into the grid. This configuration hides the necks as well as most of the frame and promotes viewing from front or back.

More recently, in 1994, James Skistimas introduced his Skistimas Design System™. This system combines the modular concept of Rouse Panels™ in a 24″ by 48″ size with a 6 inch square grid wire frame like that used by David Gully. This system adds a second layer of metal frame to each panel for increased strength and stability. It holds foil as well as latex balloons with the same look as the MagiGrid™.

A plethora of techniques and systems are employed in the trade to connect balloons for decorative purposes. However, these arrangements necessitate significant effort and are challenging to manage, while also being non-reusable. In light of these challenges, a novel inflatable and reusable balloon arch with a built-in blower has been developed. This innovative solution offers ease of use, convenience, and cost-effectiveness, making it a highly practical alternative.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the Innovative features unique to the present invention and is not intended to be a full description. A full appreciation of the various aspects of the invention can be gained by taking the entire specification, claims, drawings, and abstract as a whole.

The present invention's general objective is to provide an improved assembly related to an inflatable balloon arch with an attached blower.

One of the objectives is to offer an enhanced, convenient, and innovative reusable assembly in the form of a single piece and takes the shape of an arch with numerous balloons.

One of the essential objectives of this project is to provide a robust construction that can be deflated and stored away when not in use, thereby resulting in a space-saving and portable assembly. Ensuring that the assembly is durable enough to withstand regular usage without compromising its overall quality is imperative. The deflation feature will enable easy transportation of the assembly and also help to optimize storage space. This will be achieved through the use of high-quality materials and precise manufacturing techniques.

It is also the objective of the invention to provide ease of use to users through its ergonomic design, wherein an innovative design assists the user to use in various events without employing additional technicians and cost.

Other aspects, advantages and novel features of the present invention will become apparent from the detailed description when considered in conjunction with the accompanying drawings.

This Summary is provided merely for summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 01 is a perspective view of the Reusable inflatable Balloon Arch incorporating the embodiments of the invention.

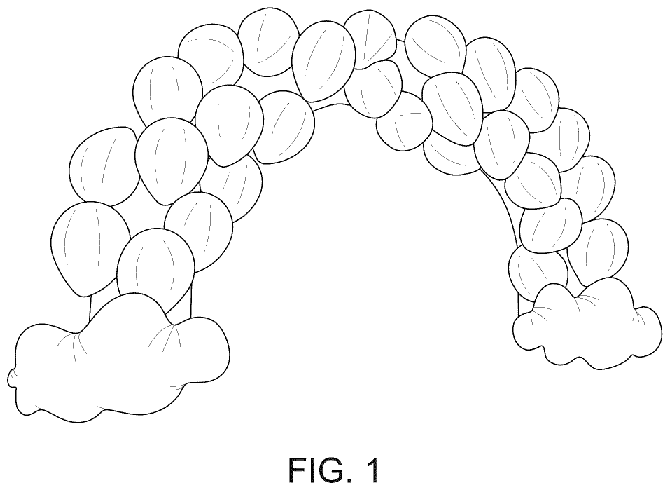

FIG. 02 is a deflated perspective view of the Reusable inflatable Balloon Arch as per preferred embodiments of the invention.

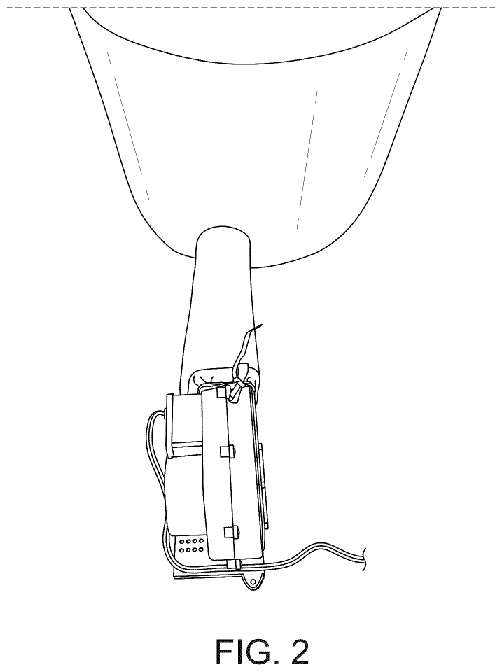

FIG. 03 shows another view of the semi-inflated Balloon Arch as per preferred embodiments of the invention.

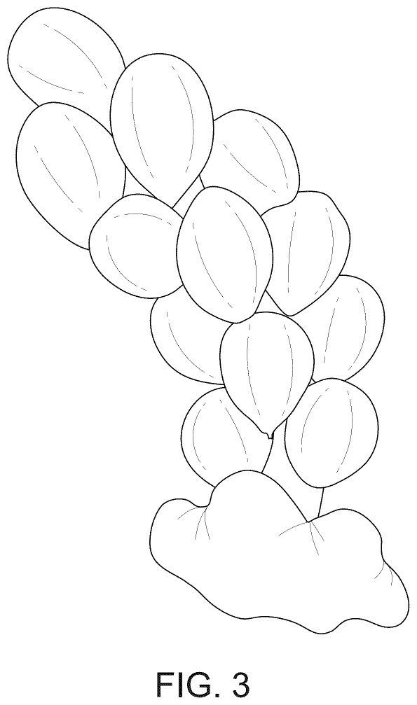

FIG. 04 is a perspective view of the semi-inflated Reusable inflatable Balloon Arch as per preferred embodiments of the invention.

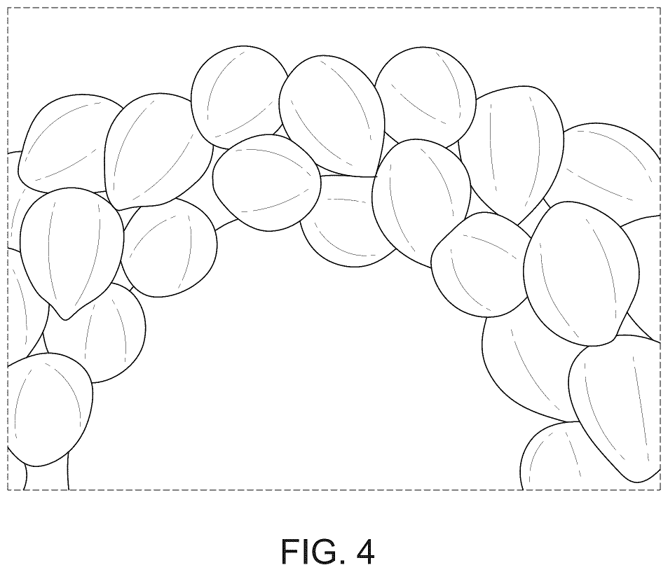

FIG. 05 is another perspective view of the semi-inflated Reusable Plastic Carrier showing its use as per preferred embodiments of the invention.

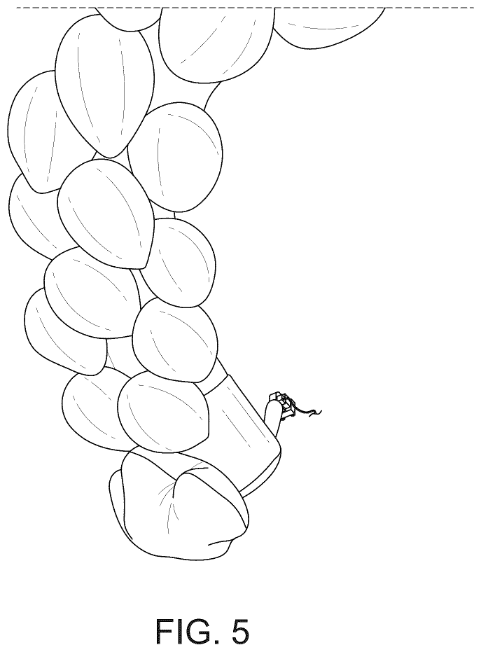

FIG. 06 shows the inflated view as per preferred embodiments of the invention.

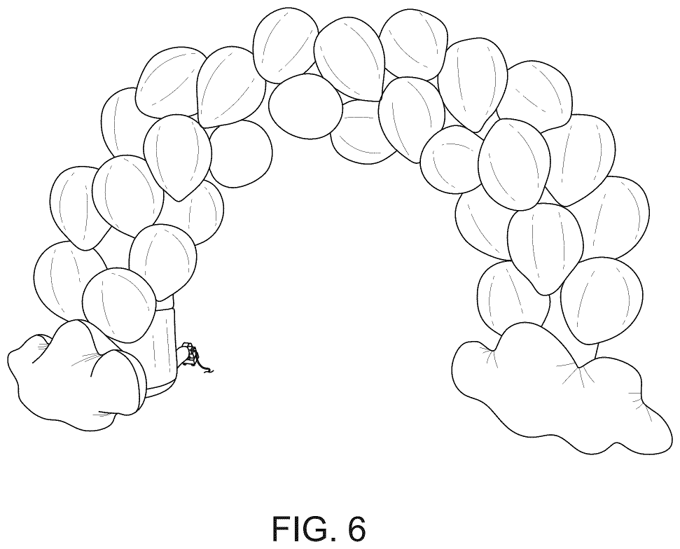

FIG. 07 the closeup view as per preferred embodiments of the invention.

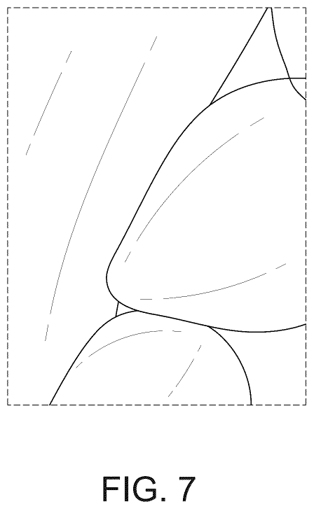

The apparatus and method components have been represented where appropriate by conventional symbols in the drawings, showing only those specific details.

### DETAILED DESCRIPTION

Detailed descriptions of the preferred embodiment are provided herein. However, it is to be understood that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is to describe particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components but do not preclude the presence or addition of one or more other features, steps, operations, elements, components, and/or groups thereof.

The present invention is directed to provide a Reusable inflatable Balloon Arch that is reliable, easy to use, and reusable.

The assembly is in the form of an inflatable balloon arch with an attached blower, an innovative, reusable, and hassle-free decoration. The arch is designed to inflate automatically when the blower is plugged in, making it incredibly easy to set up and use.

The assembly is constructed from premium materials such as polyester and rip stock, wherein the inflatable decoration is designed to be both durable and long-lasting. The arch is fabricated using 3D modeling technology, which ensures that all polyester pieces are cut and sewn together with precision, resulting in a sturdy and visually appealing arch. The arch is available in many different colors to ensure that it will match any event or occasion.

Using this arch is a simple process. After plugging in the blower, the arch inflates automatically in just 1-5 minutes, transforming into a stunning decoration for any party or celebration. Once the event is over, disconnecting the blower and unzipping the air outlets will release the air from the arch, making it easy to store for future use.

The proposed arch is a single-piece inflatable that resembles an arch made up of many balloons. The continual airflow provided by the blower ensures that the arch maintains its shape and stability, resulting in a visually striking decoration that is sure to impress guests. Disconnecting the blower will result in complete deflation of the arch, making it easy to store until its next use.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to ascertain the nature of the technical disclosure quickly. It is submitted with the understanding that it will not be used to interpret or limit the scope or meaning of the claims. In addition, in the foregoing Detailed Description, it can be seen that various features are grouped together in various embodiments to streamline the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A method of providing a reusable inflatable Balloon Arch comprising of an inflatable decoration made of polyester and rip-stock, and blower.
As per claim 1, the inflatable decoration made of polyester and rip-stock is shaped like an arch.
As per claim 1, the inflatable decoration has polyester pieces cut and sewn together.
As per claim 1, the assembly is configured to be connected with a blower.
As per claim 1, the assembly further comprises of multiple inflatable balloon-shaped structures.
As per claim 1, the assembly comprises of multiple inflatable balloons.
As per claim 1, the assembly can be deflated once the blower is plugged out.
